(19) United States
(12) Patent Application Publication
(10) Pub. No.: US 2018/0039280 A1
(43) Pub. Date: Feb. 8, 2018

(54) AUTONOMOUS MOBILE DEVICE WITH COMPUTER VISION POSITIONING SYSTEM AND METHOD FOR THE SAME

(71) Applicant: HON HAI PRECISION INDUSTRY CO., LTD., New Taipei (TW)

(72) Inventors: HORNG-JUING LEE, New Taipei (TW); TIEN-PING LIU, New Taipei (TW); SHU-FEN CHEN, New Taipei (TW); YU-CHIEN HSIAO, New Taipei (TW); YU-TAI HUNG, New Taipei (TW); FU-HSIUNG YANG, New Taipei (TW)

(21) Appl. No.: 15/394,989

(22) Filed: Dec. 30, 2016

(30) Foreign Application Priority Data
Aug. 4, 2016 (TW) 105124848

(51) Int. Cl. G05D 1/02; G01C 21/20; G01C 21/00; B60R 11/04

(52) U.S. Cl. CPC G05D 1/0274; B60R 11/04; G01C 21/20; G01C 21/005; G05D 1/0246; G05D 1/0234; B60R 2011/004

(57) ABSTRACT

An autonomous mobile device with computer vision positioning system comprises a map interpretation module, an image collection module, an artificial marker identification module, a path planning module, and an obstacle dodging module. The map interpretation stores a map of a desired moving area and a map description file corresponding to the map. The image collection module collects an image in front of the autonomous mobile device during movement in the desired moving area and form a image signal. The artificial marker identification module receives the image signal outputted by the image collection module and identifies the plurality of artificial markers of the image to achieve a positioning. The path planning module plans an optimal movement information of the autonomous mobile device moving between the plurality of artificial markers. The obstacle dodging module controls the autonomous mobile device to dodge an obstacle autonomously.

### CROSS-REFERENCE TO RELATED APPLICATIONS

This application claims all benefits accruing under 35 U.S.C. §119 from TW Patent Application No. 105124848, filed on Aug. 4, 2016, in the TW Intellectual Property Office, the contents of which are hereby incorporated by reference.

### FIELD

The subject matter herein generally relates to an autonomous mobile device with computer vision positioning system and a method for the same.

### BACKGROUND

Simultaneous localization and mapping (SLAM) is commonly used in an autonomous mobile device for positioning. SLAM means that the autonomous mobile device can start from a strange environment location, and establish its own location and posture by repeatedly observing map features during a movement; then incrementally constructing a map, so as to achieve a self-locating and map-construction simultaneously. SLAM commonly achieves positioning by more information from the sensor, such as GPS, IMU, Odometry. When the autonomous mobile device moves by universal wheel or omni wheel, the odometry can not provide a reference to a moving distance, and the GPS cannot be used in an interior room environment.

An artificial marker can be used to achieve computer vision positioning, so as not to use IMU. However, when one autonomous mobile device is in different conditions, the same motor output can not reach the same moving distance. Although the autonomous mobile device can reach the destination, the autonomous mobile devices move clumsily.

### BRIEF DESCRIPTION OF THE DRAWINGS

Implementations of the present technology will now be described, by way of example only, with reference to the attached figures, wherein:

FIG. 1 is a schematic view of a module of an autonomous mobile device with computer vision positioning system in one embodiment.

FIG. 2 is a flow chart of a positioning method of an autonomous mobile device with computer vision positioning system in one embodiment.

FIG. 3 is a schematic view of a robot moving in an area of example 1.

### DETAILED DESCRIPTION

The disclosure is illustrated by way of example and not by way of limitation in the figures of the accompanying drawings in which like references indicate similar elements. It should be noted that references to “another,” “an,” or “one” embodiment in this disclosure are not necessarily to the same embodiment, and such references mean “at least one.”

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts have been exaggerated to illustrate details and features of the present disclosure better.

Several definitions that apply throughout this disclosure will now be presented.

The term “substantially” is defined to be essentially conforming to the particular dimension, shape, or other feature described, such that the component need not be exactly conforming to such feature. The term “comprise,” when utilized, means “include, but not necessarily limited to”; it specifically indicates open-ended inclusion or membership in the so-described combination, group, series, and the like.

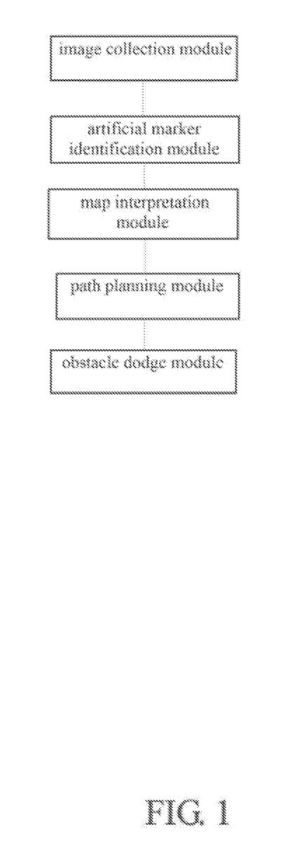

Referring to FIG. 1, the present disclosure is described in relation to an autonomous mobile device with a computer vision positioning system. The autonomous mobile device with the computer vision positioning system comprises a map interpretation module, an image collection module, an artificial marker identification module, a path planning module, and an obstacle dodging module. The map interpretation module stores a map of a desired moving area and a map description file corresponding to the map. A plurality of artificial markers are located in the desired moving area, and the autonomous mobile device moves between the plurality of artificial markers. The image collection module collects an image in front of the autonomous mobile device during the movement in the desired moving area and forms an image signal, and transmits the image signal to the artificial marker identification module. The artificial marker identification module receives the image signal outputted by the image collection module and identifies the plurality of artificial markers of the image, to achieve a positioning. The path planning module plans an optimal movement information of the autonomous mobile device moving between the plurality of artificial markers. The obstacle dodging module controls the autonomous mobile device to dodge any obstacle autonomously.

The autonomous mobile device can be any mobile device, such as a robot or unmanned vehicle. The autonomous mobile device can move on feet or on wheels.

The desired moving area can be a workplace, such as a workshop, a restaurant, or a tourist station. The plurality of artificial markers is located in the desired moving area. Each artificial marker corresponds to an ID. The ID may include a number or a character. The ID represents a name of an artificial marker, such as a corner. The artificial markers can be Tag36h11 marker series, Tag36h10 marker series, Tag25h9 marker series, or Tag16h5 marker series.

The map interpretation module stores the map of the desired moving area and the map description file corresponding to the map. The map is stored in a designated mark language (XML) or another format file, wherein the artificial marker is defined. The map description file includes a description of a vicinity of the artificial marker on the map. The map description file may be a place name marked by the artificial marker on the map.

The image collection module comprises a camera. The camera is located on a side of the autonomous mobile device facing a moving direction of the autonomous mobile device to capture the image in a field of view, so as to be capable of capturing the artificial marker. The image collection module transmits the image to the artificial marker identification module through a data line. The camera can be a web camera based on Charge-coupled Device (CCD) or Complementary Metal Oxide Semiconductor (CMOS).

The artificial marker identification module receives the image captured by the image collection module, and reads and identifies the artificial marker in the image. The artificial marker identification module transmits the artificial marker to the map interpretation module, to determine a position and an angle of the autonomous mobile device relative to the artificial marker, so as to realize positioning.

The path planning module plans an optimal movement information of the autonomous mobile device moving between two artificial markers. The autonomous mobile device can move from an artificial marker A to an artificial marker B by several paths. In one embodiment, the autonomous mobile device moves from the artificial marker A, and goes straight forward five steps and then back one step to reach the artificial marker B by a first path. In another embodiment, the autonomous mobile device moves from the artificial marker A and goes straightforward four steps to reach the artificial marker B by a second path. The second path does not need to go back, so the second path is the most accurate and shortest path. Thus the optimal movement information of the autonomous mobile device moving from the artificial marker A to the artificial marker B is the second path.

If the autonomous mobile device encounters an obstacle in the desired moving area, the obstacle dodging module will activate a dodge function to dodge the obstacle automatically.

The autonomous mobile device can be connected to a central control center. The autonomous mobile device can include a first data transmission module. The center control center comprises a second data transmission module and a mobile instruction module. The second data transmission module is connected to the mobile instruction module. The first data transmission module is connected to the second data transmission module. The first data transmission module is used to transmit the position of the autonomous mobile device in the map marked with the artificial marker to the second data transmission module. A remote user can give an instruction to make the autonomous mobile device arrive at the destination by the mobile instruction module according to the position of the autonomous mobile device. The first data transmission module receives the instruction and transmits the instruction to an autonomous mobile device control module, and the autonomous mobile device control module controls the autonomous mobile device to move forward and arrive at the destination.

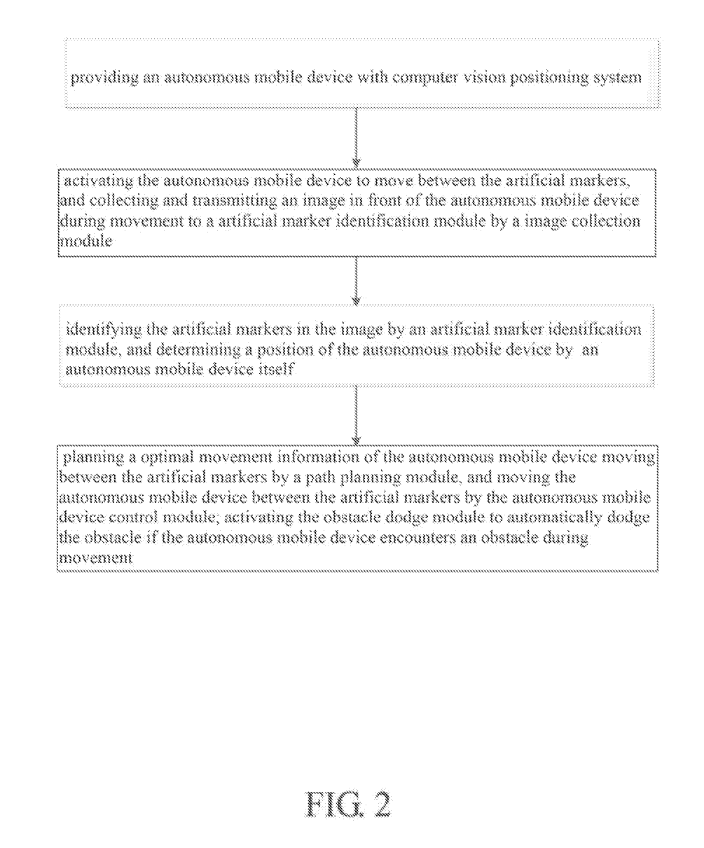

FIG. 2 illustrates one embodiment of a positioning method of a computer vision positioning system comprising the following steps:
S1: providing an autonomous mobile device with a computer vision positioning system comprising a map interpretation module, an image collection module, an artificial marker identification module, a path planning module, and an obstacle dodging module;
S2: activating the autonomous mobile device to move between a plurality of artificial markers, and collecting and transmitting an image in front of the autonomous mobile device during movement to the artificial marker identification module by the image collection module;
S3: identifying the plurality of artificial markers in the image by the artificial marker identification module, and determining a position of the autonomous mobile device by the autonomous mobile device itself;
S4: planning an optimal movement information of the autonomous mobile device moving between the plurality of artificial markers by the path planning module, and moving the autonomous mobile device between the plurality of artificial markers by an autonomous mobile device control module; activating an obstacle dodging module to dodge an obstacle automatically if the autonomous mobile device encounters the obstacle during movement.

In step S3, the artificial marker identification module determines which one of the image is similar to the artificial marker and marks it as a similar artificial marker, and identifies whether the similar artificial marker is the artificial marker. If the similar artificial marker is the artificial marker, the artificial marker identification module reads and transmits the ID of the artificial marker to the map interpretation module, to make the autonomous mobile device determine its own position. The artificial marker identification module can calculate a distance and an angle between the autonomous mobile device and the artificial marker according to a collected artificial marker. The autonomous mobile device control module can fine tune the autonomous mobile device to move to the artificial marker.

In step S4, the path planning module has a fixed algorithm to calculate a most accurate and shortest path as the optimal mobility information. The autonomous mobile device control module controls the autonomous mobile device to move between the plurality of artificial markers. If the autonomous mobile device encounters an obstacle during the movement, the obstacle dodging module will activate the dodge function to dodge the obstacle automatically and then continue to move to the destination.

The autonomous mobile device can be connected to a central control center. The autonomous mobile device can include a first data transmission module. The center control center comprises a second data transmission module and a mobile instruction module. The second data transmission module is connected to the mobile instruction module. The first data transmission module is connected to the second data transmission module.

The first data transmission module is used to transmit the position of the autonomous mobile device in the map marked with the plurality of artificial markers to the second data transmission module. The central control center transmits an instruction to the second data transmission module through the mobile instruction module according to the position of the autonomous mobile device. This instruction instructs the autonomous mobile device to reach the destination. The second data transmission module transmits the instruction to the first data transmission module. The first data transmission module receives the instruction from the second data transmission module and transmits the instruction to the autonomous mobile device control module. The autonomous mobile device control module controls the autonomous mobile device to move and arrive at the destination.

In the autonomous mobile device with a computer vision positioning system and a method for the same, the map of the desired moving area and the map description file corresponding to the map are stored in the autonomous mobile device. The optimal movement information of the autonomous mobile device moving between the plurality of artificial markers is planned by the path planning module. The obstacle dodging module controls the autonomous mobile device to dodge the obstacle. Thus, the autonomous mobile device can move more smoothly in the desired moving area.

### EXAMPLE 1

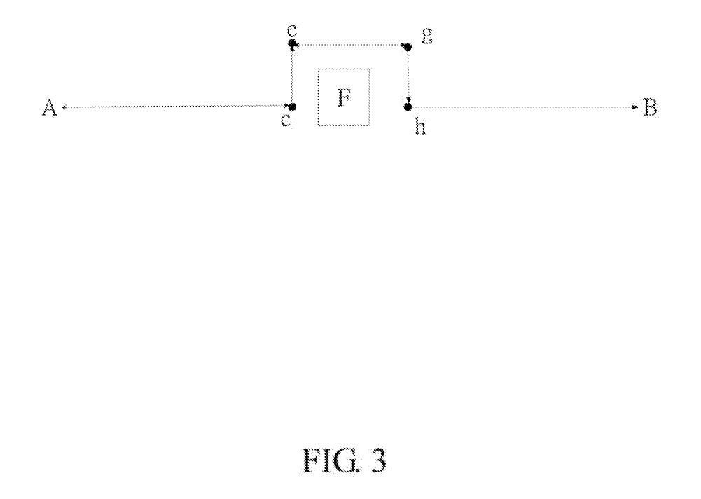

Referring to FIG. 3, a robot moves within an area of a plant. An artificial marker A and an artificial marker B are located in the area. The robot moves from the artificial marker A to the artificial marker B. The path planning a optimal movement information from the artificial marker A to the artificial marker B. The autonomous mobile device control module controls the autonomous mobile device to move from the artificial marker A to the artificial marker B. When the robot encounters an obstacle F in the process of movement, the robot moves to point c and finds that it can not move forward, the robot will activate the obstacle dodging module to automatically dodge the obstacle F. The robot moves left by 4 steps to reach a point e, and finds it can move forward according to an original route. Then the robot continuously moves forward by 4 steps to reach a point g and moves right 4 steps to reach a point h and moves forward according to the original route to reach the artificial marker B.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

Finally, it is to be understood that the above-described embodiments are intended to illustrate rather than limit the disclosure. Variations may be made to the embodiments without departing from the spirit of the disclosure as claimed. Elements associated with any of the above embodiments are envisioned to be associated with any other embodiments. The above-described embodiments illustrate the scope of the disclosure but do not restrict the scope of the disclosure.

What is claimed is:

1. An autonomous mobile device comprising:
a map interpretation module configured to store a map of a desired moving area and a map description file corresponding to the map, wherein a plurality of artificial markers are located in the desired moving area;
an image collection device configured to collect an image in front of the autonomous mobile device during the autonomous mobile device moving in the desired moving area and form an image signal;
an artificial marker identification module configured to receive the image signal outputted by the image collection device, and identify the plurality of artificial markers in the image to achieve a positioning of the autonomous mobile device;
a path planning module configured to plan a preferred movement information of the autonomous mobile device moving between the plurality of artificial markers; and
an obstacle dodging module configured to control the autonomous mobile device to dodge an obstacle autonomously.

2. The autonomous mobile device of claim 1, wherein the plurality of artificial markers are selected from the group consisting of Tag36h11 marker series, Tag36h10 marker series, Tag25h9 marker series, and Tag16h5 marker series.

3. The autonomous mobile device of claim 1, wherein the image collection device comprises a camera, and the camera is located on a side of the autonomous mobile device facing a moving direction of the autonomous mobile device to capture the image in a field of view.

4. The autonomous mobile device of claim 3, wherein the camera is a web camera based on Charge-coupled Device or Complementary Metal Oxide Semiconductor.

5. The autonomous mobile device of claim 1, wherein the autonomous mobile device is connected to a central control center, the central control center comprises a second data transmission module and a mobile instruction module, and the second data transmission module is connected to the mobile instruction module.

6. The autonomous mobile device of claim 5, wherein the autonomous mobile device comprises a first data transmission module, and the first data transmission module is connected to the second data transmission module.

7. A positioning method of a computer vision positioning system comprising:
S1: providing an autonomous mobile device comprising a map interpretation module, an image collection device, an artificial marker identification module, a path planning module, and an obstacle dodging module;
S2: activating the autonomous mobile device to move between a plurality of artificial markers, and collecting and transmitting an image in front of the autonomous mobile device during movement to the artificial marker identification module by the image collection device;
S3: identifying the plurality of artificial markers in the image by the artificial marker identification module, and determining a position of the autonomous mobile device by the autonomous mobile device itself;
S4: planning a preferred movement information of the autonomous mobile device moving between the plurality of artificial markers by the path planning module, and moving the autonomous mobile device between the plurality of artificial markers by an autonomous mobile device control module; and activating the obstacle dodging module to dodge an obstacle automatically if the autonomous mobile device encounters the obstacle during movement.

8. The method of claim 7, wherein the artificial marker identification module identifies the plurality of artificial marker from the image, and reads and transmits an ID of the plurality of artificial markers to the map interpretation module, to make the autonomous mobile device determine its own position.

9. The method of claim 8, wherein the artificial marker identification module calculates a distance and an angle between the autonomous mobile device and the plurality of artificial markers, and the autonomous mobile device control module fine tunes the autonomous mobile device to move to the plurality of artificial markers.

10. The method of claim 7, wherein the autonomous mobile device is connected to a central control center, the central control center comprises a second data transmission module and a mobile instruction module, and the second data transmission module is connected to the mobile instruction module; the autonomous mobile device comprises a first data transmission module, and the first data transmission module is connected to the second data transmission module.

11. The method of claim 10, wherein the first data transmission module transmits a position of the autonomous mobile device in a map marked with the plurality of artificial markers to the second data transmission module, the central control center transmits an instruction to the second data transmission module through the mobile instruction module according to the position of the autonomous mobile device, the second data transmission module transmits the instruction to the first data transmission module, the first data transmission module transmits the instruction to the autonomous mobile device control module, and the autonomous mobile device control module controls the autonomous mobile device to move and arrive at a destination.
